(19) United States
(12) Patent Application Publication
(10) Pub. No.: US 2021/0340027 A1
(43) Pub. Date: Nov. 4, 2021

(54) PROCESS AND SYSTEM FOR REMOVING HYDROGEN SULFIDE FROM SOUR WATER

(71) Applicants: Swade Holowatuk, Airdrie (CA); Brian George Kergan, Calgary (CA); Ken Donald Wilson, Fort St. John (CA); Michael Stuart Jones, Calgary (CA)

(72) Inventors: Swade Holowatuk, Airdrie (CA); Brian George Kergan, Calgary (CA); Ken Donald Wilson, Fort St. John (CA); Michael Stuart Jones, Calgary (CA)

(21) Appl. No.: 17/274,385

(22) PCT Filed: Sep. 6, 2018
(86) PCT No.: PCT/CA2018/051085

§ 371 Date: Mar. 8, 2021

(51) Int. Cl. C02F 1/20; B01D 19/00; C02F 1/66

(52) U.S. Cl. CPC C02F 1/20; C02F 2101/101; C02F 1/66; B01D 19/0005

(57) ABSTRACT

A process for removing hydrogen sulfide from sour water is provided. The process comprises obtaining sour water; adjusting the pH of the sour water to a pH of less than about 6 by addition of a first acid to form acidified sour water; sparging the acidified sour water with a first hydrocarbon gas in a first vessel to produce a first sour gas and a sweetened water; and separating the first sour gas from the sweetened water.

### FIELD OF THE INVENTION

The present invention pertains to a process and system for removing hydrogen sulfide from sour water.

### BACKGROUND

In the past 10 years there have been substantial technological advances as it pertains to well completions in the North American Oil and gas industry. These advances come with new challenges. One of those challenges is handling, treating and re-use of completion fluids.

Hydraulic fracturing, commonly known as fracking, is a technique designed to enhance the recovery of gas and oil from shale rock. Fracking is a process that occurs after the drilling and completion of the well. When fracking is executed, a high-pressure water mixture is directed at the rock to break up the rock and release the gas and hydrocarbon liquids from the formation.

Hydrogen sulfide (H₂S), is a naturally occurring chemical in the hydrocarbon liquids, natural gas and formation water, and is present during drilling operations. H₂S is a highly corrosive acid gas, and can cause corrosion to pipelines and other equipment, and pose significant health and safety risks to the community. Flowback water from fracking operations can become contaminated with H₂S, forming what is known as “sour water”. Given the corrosiveness as well as the health and safety risks of H₂S, sour water is dangerous both to transport and to store. In addition, there is a ‘zero tolerance’ on any amount of H₂S entrained in water that is to be re-used/recycled for fracking.

Methods to remove H₂S from sour water are known in the art. Such methods can include chemical sweetening, such as using H₂S scavengers. One example of an H₂S scavenger is a chemical known as triazine. However, H₂S scavengers can add to processing costs. There are also concerns around potential long-term health effects of the use of H₂S scavengers as a chemical sweetening agent. In addition, H₂S scavengers have a potential to create high scaling tendencies in treated water. Other methods for removing H₂S from sour water include the application of excessive heat, which can also increase processing costs, and aeration which in the inventors' experience can increase the risk of combustion. The use of fuel gas for removal of H₂S via stripping towers is also known, although the use of stripping towers adds to equipment costs and towers can be susceptible to plugging.

U.S. Pat. No. 9,028,679 to Anschutz Exploration Corporation is directed to a system and method to remove H₂S from sour water and sour oil. Embodiments disclosed in U.S. Pat. No. 9,028,679 use aeration to remove H₂S in an enclosed environment (see col. 11, lines 10-15).

U.S. Pat. No. 8,518,159 discloses a process and process line for treating water containing hydrogen sulfide for use as a hydraulic fracturing fluid. The process steps involve: separating a gaseous portion containing hydrogen sulfide from the water to form a first degassed water product; introducing the first degassed water product into a mechanical gas stripping unit and treating the first degassed water product with a stripper gas; recovering from the mechanical gas stripping unit at least one overhead vapor stream containing hydrogen sulfide and a stripped water stream as a bottom stream; degassing the stripped water stream in a degassing tank to produce a second degassed water product; and treating the second degassed water product with a hydrogen sulfide scavenger to produce a sweet water product having substantially reduced hydrogen sulfide (see Abstract).

There is a need for further systems and processes for removing H₂S from sour water to render the water suitable for storage and transportation. Such sweetened water could be stored on-site at fracking locations in surface storage, and possibly re-used for fracking applications.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

Described herein is a process for removing hydrogen sulfide from sour water, comprising: obtaining sour water; adjusting the pH of the sour water to a pH of less than about 6 by addition of a first acid to form acidified sour water; sparging the acidified sour water with a first hydrocarbon gas in a first vessel to produce a first sour gas and a sweetened water; and separating the first sour gas from the sweetened water.

### BRIEF DESCRIPTION OF THE FIGURES

For a better understanding of the present invention including the progression of development to get to the end product, reference is made to the following description which is to be used in conjunction with the accompanying drawings, where:

FIG. 1(a) illustrates a pilot test flow schematic for sour water sweetening using a ‘basic mixer’ to test the effectiveness of using sweet gas (shown as “fuel gas” in the figure) with static mixing without any other additional sweetening methods. FIG. 1(b) summarizes the results of the ‘basic mixer’ test.

FIG. 2(a) illustrates a flow schematic in which the basic static mixing test similar to that outlined in FIG. 1(a) was performed on a larger scale using a 1000 bbl production tank located at the Todd Energy central facility. FIG. 2(b) summarizes the results of this pilot test.

FIG. 3(a) illustrates a flow schematic in which the basic test using a P-tank equipped with a sparging device was performed, in order to sparge the sour water with sweet gas (shown in the figure as “fuel gas”). FIG. 3(b) summarizes the results of pilot tests with the P-tank and sparging device.

FIG. 4(a) illustrates a flow schematic in which the features of a recycle loop and static mixer were added to the setup shown in FIG. 3(a). FIG. 4(b) summarizes the results of pilot tests with this process and system.

FIG. 5(a) illustrates a 1 L bottle test wherein sour water was sweetened by a one-time pH adjustment to pH 4 with hydrochloric acid (HCl), coupled with sparging of the sour water with sweet gas. FIG. 5(b) summarizes the results of this pilot test.

FIG. 6 illustrates experimental conditions and results obtained for 10 L bottle tests performed wherein different acids were used to adjust the pH of the water in conjunction with sparging of the sour water with sweet gas.

FIG. 7 illustrates experimental conditions and results obtained for a 1 L bottle test wherein sour water was sweetened by a one-time pH adjustment to pH 4 with hydrochloric acid (HCl), coupled with sparging of the sour water with sweet gas, under heating conditions.

FIG. 8(a) illustrates a flow schematic for a 10:1 scale test with a 100 barrel (bbl) tank wherein sweet gas sparging technology was coupled with pH adjustment using HCl, together with a recycle loop, to sweeten sour water. FIGS. 8(b) and 8(c) are pictures of the 100 bbl tank used and sparging device comprising sparging fingers that was used for sparging the sour water housed in the tank with sweet gas. FIG. 8(d) is a simplified schematic of the sparging device installed in the tank. FIGS. 8(e), 8(f), and 8(g) show the results of three separate experiments using this system and process.

FIG. 9 illustrates how the present system and process could be used for water sweetening via multi-stage treatment in series.

### DETAILED DESCRIPTION OF THE INVENTION

### Definitions

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) ingredient(s) and/or elements(s) as appropriate.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

As used herein, the term “sour water” refers to water containing hydrogen sulfide (H₂S). In some embodiments, sour water may contain H₂S in an amount greater than about 16 ppm (about 0.0016%). In another embodiment where water is being used for fracking purposes, such water may be considered sour water if it has a measurable amount of H₂S (i.e. greater than 0 ppm).

As used herein, the term “sour gas” refers to a hydrocarbon gas, such as natural gas, containing hydrogen sulphide (H₂S) in excess of about 16 ppm (about 0.0016%).

As used herein, the term “hydrocarbon gas” refers to a gaseous organic compound comprising hydrogen and carbon that occurs as a gas at atmospheric pressure and can occur as a liquid under higher pressures, for example natural gas and components thereof, such as methane. Natural gas is a naturally occurring mixture of hydrocarbon gases that is highly compressible and expansible. Methane (CH₄) is the main component of most natural gas (constituting as much as 85% of some natural gases), with lesser amounts of ethane (C₂H₆), propane (C₃H₈), butane (C₄H₁₀) and pentane (C₅H₁₂).

As used herein, the term “sweet gas” refers to a hydrocarbon gas, such as natural gas, that does not contain H₂S, or which contains equal to or less than about 16 ppm of H₂S (about 0.0016%).

As used herein, the terms “sweet,” “sweetened,” and/or “sweetening” mean a product that has low levels of H₂S, has had H₂S removed, or the process of removing H₂S.

Description of Process and System

Described herein is a process and system by which H₂S is removed from sour water using a combination of sparging technology, pH adjustment and, optionally, heat.

In one embodiment, there is provided a process for removing hydrogen sulfide from sour water, comprising: obtaining sour water; adjusting the pH of the sour water to a pH of less than about 6 by addition of a first acid to form acidified sour water; sparging the acidified sour water with a first hydrocarbon gas in a first vessel to produce a first sour gas and a sweetened water; and separating the first sour gas from the sweetened water.

In another embodiment, the first acid comprises hydrochloric acid, acetic acid, or a combination thereof. In another embodiment, the first acid is hydrochloric acid.

In yet another embodiment, the first hydrocarbon gas is sweet gas.

In still another embodiment, the pH of the acidified sour water is from about 3.5 to about 5.5. In another embodiment, the pH of the acidified sour water is from about 4 to about 5. In yet another embodiment, the pH is maintained substantially constant during the process.

In still yet another embodiment, the first vessel comprises a first sparging device for sparging the acidified sour water with the first hydrocarbon gas, the first sparging device being located at a base of the first vessel.

In another embodiment, the first sparging device comprises at least one sparging finger fluidly connected to a source of the first hydrocarbon gas and disposed horizontally within the first vessel, wherein the sparging finger comprises a pipe with a plurality of orifices for releasing the first hydrocarbon gas into the first vessel. In yet another embodiment, the plurality of orifices are evenly spaced apart from one another. In still yet another embodiment, the first sparging device comprises a plurality of sparging fingers which are preferably evenly spaced apart from one another.

In one embodiment the orifices of the sparging device can have a size of from about 1.5 mm to about 5 mm in diameter, preferably from about 2 mm (approximately 5/64 inch) to about 5 mm in diameter. In another embodiment, the orifices of the sparging device can be spaced from about 10 cm to about 20 cm (about 4 to about 8 inches) apart from one another.

In still yet another embodiment, the process further comprises: removing a portion of the sour water from the first vessel, optionally via an outlet disposed at the base of the first vessel; mixing, externally to the first vessel, the portion of the sour water from the first vessel together with a portion of the first hydrocarbon gas, and optionally a portion of the first acid, to form a first mixture; and providing the first mixture to the first vessel; optionally, wherein the first mixture is provided to the first vessel via an inlet disposed at an end of the first vessel opposite from the base of the first vessel.

In another embodiment, said mixing is carried out using a first static mixer. In another embodiment, said steps of removing the portion of the sour water from the first vessel; mixing, externally to the first vessel, the portion of the sour water from the first vessel together with the portion of the first hydrocarbon gas, and optionally the portion of the first acid, to form the first mixture; and providing the first mixture to the first vessel are performed periodically during the process for removing hydrogen sulfide from the sour water. In still yet another embodiment, these process steps are performed continuously during the process for removing hydrogen sulfide from the sour water.

In still yet another embodiment, the process further comprises incinerating the first sour gas following the step of separating the first sour gas from the sweetened water. In another embodiment, the process further comprises sending the first sour gas to a vapour recovery unit to be sweetened and recycled to the process following the step of separating the first sour gas from the sweetened water.

In still yet another embodiment, the process further comprises: providing the sweetened water formed in the first vessel to a second vessel; adjusting the pH of the sweetened water to or maintaining the pH of the sweetened water at a pH of less than about 6 by addition of a second acid to the sweetened water, as needed, to form or maintain acidified sweetened water; sparging the acidified sweetened water in the second vessel with a second hydrocarbon gas to produce a second sour gas and a further sweetened water; and separating the second sour gas from the further sweetened water.

In yet another embodiment, the second acid comprises hydrochloric acid, acetic acid, or a combination thereof. In another embodiment, the second acid is hydrochloric acid.

In another embodiment, the second hydrocarbon gas is sweet gas.

In another embodiment, the pH of the acidified sweetened water is from about 3.5 to about 5.5. In another embodiment, the pH of the acidified sweetened water is from about 4 to about 5. In still yet another embodiment, the pH is maintained substantially constant during the process.

In yet another embodiment, the second vessel comprises a second sparging device for sparging the acidified sweetened water with the second hydrocarbon gas, the second sparging device being located at a base of the second vessel.

In another embodiment, the second sparging device comprises at least one sparging finger fluidly connected to a source of the second hydrocarbon gas and disposed horizontally within the second vessel, wherein the sparging finger comprises a pipe with a plurality of orifices for releasing the second hydrocarbon gas into the second vessel. In another embodiment, the plurality of orifices are evenly spaced apart from one another. In still yet another embodiment, the second sparging device comprises a plurality of sparging fingers which are preferably evenly spaced apart from one another.

In another embodiment, the process further comprises: removing a portion of the sweetened water from the second vessel optionally via an outlet disposed at the base of the second vessel; mixing, externally to the second vessel, the portion of the sweetened water from the second vessel together with a portion of the second hydrocarbon gas, and optionally a portion of the second acid, to form a second mixture; and providing the second mixture to the second vessel; optionally, wherein the second mixture is provided to the second vessel via an inlet disposed at an end of the second vessel opposite from the base of the second vessel.

In still another embodiment, said mixing is carried out using a second static mixer.

In another embodiment, said steps of removing the portion of the sweetened water from the second vessel; mixing, externally to the second vessel, the portion of the sweetened water from the second vessel together with the portion of the second hydrocarbon gas, and optionally the portion of the second acid, to form the second mixture; and providing the second mixture to the second vessel are performed periodically during the process for removing hydrogen sulfide from the sour water. In yet another embodiment, such steps are performed continuously during the process for removing hydrogen sulfide from the sour water.

In yet another embodiment, the process further comprises incinerating the second sour gas following the step of separating the second sour gas from the further sweetened water. In another embodiment, the process further comprises sending the second sour gas to the vapour recovery unit to be sweetened and recycled to the process following the step of separating the second sour gas from the further sweetened water.

In another embodiment, the sweetened water is sent to a storage tank following the step of separating the first sour gas from the sweetened water.

In still another embodiment, the further sweetened water is sent to a storage tank following the step of separating the second sour gas from the further sweetened water.

In yet another embodiment, the process further comprises providing the further sweetened water formed in the second vessel to a third vessel for further sweetening of the water.

In another embodiment, the first acid and the second acid are the same acid. In yet another embodiment, the first acid and the second acid are hydrochloric acid.

In another embodiment, the first hydrocarbon gas and the second hydrocarbon gas are the same gas. In yet another embodiment, the first hydrocarbon gas and the second hydrocarbon gas are sweet gas.

In still yet another embodiment, the process is conducted in an oxygen-free environment.

In another embodiment, the process further comprises heating the first vessel during the process. In another embodiment where a first and second vessel are present, the process further comprises heating the first vessel and/or heating the second vessel during the process. In another embodiment, the water to be sweetened is heated in the first/second vessel to a temperature of from about 25° C. to about 50° C.

As noted above, the sparging device is preferably located at the base of the vessel housing the water to be sweetened. For a cylindrical tank, the sparging device may comprise one or more central pipes fluidly connected to a source of sweet gas and running along the diameter of tank; for an elongate tank, the sparging device may comprise one or more central pipes fluidly connected to a source of sweet gas and disposed centrally in tank (i.e. evenly spaced between side walls that run lengthwise), running along the long axis of the tank. In such embodiments, sparging fingers can be spaced evenly apart along the length of the central pipe(s), fluidly connected thereto and extending outwardly therefrom, such as at roughly right angles.

The process and system of the present application do not require the use of stripping columns/towers and provide an advantage over prior art processes and systems utilizing such stripping columns/towers and the like, in terms of simplicity of design and cost benefits. It is estimated that the sparging device having sparging fingers that is used in the processes described herein would incur a small fraction of the cost of a stripping tower, thus providing lower capital operations. In addition, while stripping towers are typically limited to use in flow-through processes, the process and system described herein lend themselves to use in a batch process setting. The batch process would consist of transporting the sour water to a sparging tank, then sweetening the water to an H₂S content of approximately 20 ppm, then ‘polishing’ this water using an agent such as hydrogen peroxide or acrolein to obtain an H₂S content of 0 ppm, in particular if the sweetened water is to be used for fracking purposes.

Static mixers suitable for use in the present system and process are known to those of skill in the art. For instance, a static mixer such as the Sulzer SMV static mixer could be used; however, any motionless mixing device that allows for the inline continuous blending of fluids within a pipeline could be used. In embodiments tested in the Examples below, a section of pipe filled with stainless steel parts including wingnuts to increase blending of liquids and gases through the pipe functioned as a static mixer.

### EXAMPLES

To gain a better understanding of the invention described herein, the following examples are set forth. It should be understood that these examples are for illustrative purposes only. Therefore, they should not limit the scope of this invention in any way.

Materials and Methods

Synthetic Acid, Hydrochloric Acid, and Acetic Acid used for pH adjustment in the Examples below were purchased from Halliburton/Multi-Chem. The P-tank used for initial sparge testing in Example 2 below was rented from Colter Energy Services Inc. The 100 barrel (bbl) tank and 1000 bbl tank referenced in other Examples were property of Todd Energy Company of Canada (“Todd Energy”).

Testing of hydrogen sulfide levels in water in the Examples below was carried out using the hydrogen sulfide test kit HS-C, Product #2537800 from Hach (referred to as “Hach test” below in and in Figures). Testing of hydrogen sulfide levels in the gas phase was carried out using an H₂S detector tube (Model GV-110 from Gastec Corporation).

In the Examples below, improvised static mixers of either 1 inch nominal pipe size (NPS) by 10 feet, or 2 inch NPS by 10 feet were used where noted. These static mixers were constructed from a section of pipe having the latter (downstream) 3 feet filled with stainless steel parts including wingnuts to increase blending of liquids and gases through the pipe.

The sweet gas (also shown in the Figures as “fuel gas”) used in the Examples below was obtained from the Todd Energy central facility. It is noted that the sweet gas used in the Examples was dehydrated prior to use, as dehydration of the sweet gas was required for other applications; however, it is envisioned that sweet gas that has not been dehydrated could equivalently be used in the processes described herein.

### Comparative Example 1

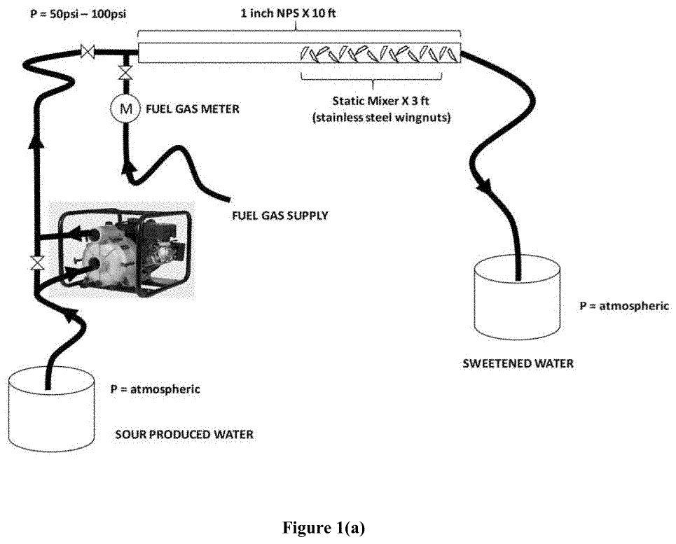

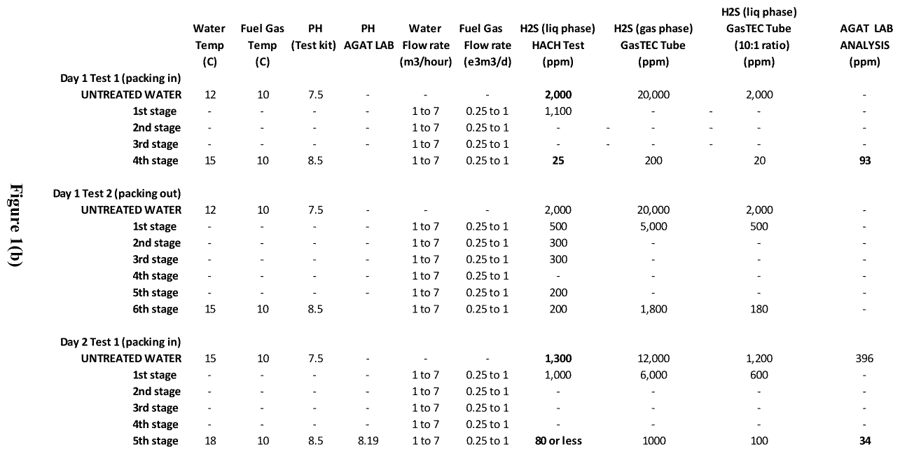

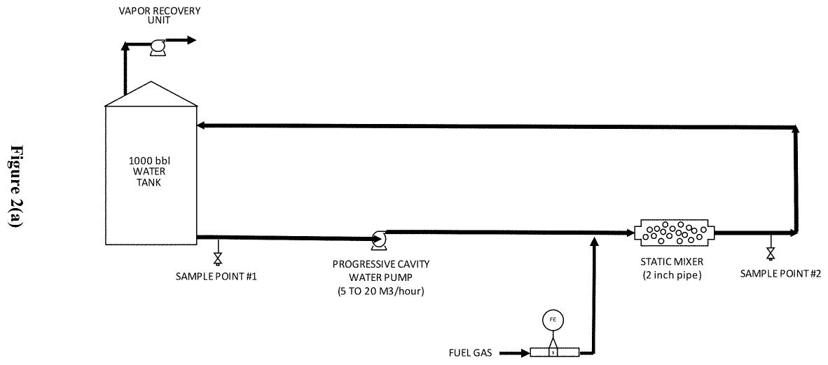

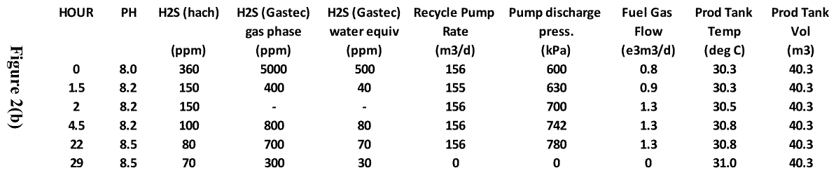

A pilot test for sour water sweetening was carried out initially using only static mixing technology, as illustrated in FIGS. 1(a), 1(b), 2(a) and 2(b).

Turning to the test and results as outlined in FIGS. 1(a) and 1(b), sour water was obtained from a three-phase separator well pad site located at C-12-I/94-A-13 (British Columbia). The sour water was pumped through a water line and mixed with sweet gas fed through a fuel gas meter into the line, and the mixture was pumped into the improvised static mixer described above (1 inch NPS) at a pressure of from about 50 psi to about 100 psi. Sweetened water emerging from the static mixer was collected and stored at atmospheric pressure, and subjected to testing for H₂S content using the Hach test for detecting ppm levels of H₂S in the liquid phase of the water, and gas phase testing (Gastec) as described above, wherein H₂S in the gas phase was vented from the sample at atmospheric pressure. The sweetened water was subjected to a second stage of sweetening, and was again pumped through the water line, mixed with sweet gas, and pumped into the improvised static mixer as described above, and the further sweetened water emerging from the static mixer was again collected and stored at atmospheric pressure, and subjected to further testing for H₂S content. This process was repeated for a number of stages of sweetening as shown in FIG. 1(b).

To measure H₂S levels in the gas phase, the storage container was agitated slightly and gas phase measurements were taken. H₂S measurements in the gas phase were for the purposes of confirming data obtained using the liquid phase Hach test as described above. A ratio of gas phase H₂S to liquid phase H₂S was calculated, as it was found that, depending on the temperature of the fluid and amount of agitation, ppm levels of gas phase H₂S were generally approximated to be 10 times the level of H₂S entrained in the liquid phase in water (i.e. roughly a 10:1 ratio of gas: liquid levels of H₂S). Thus, dividing the gas phase results by 10 offered a quick confirmation of values obtained via the liquid phase Hach test described above.

Further experimental details are shown in the chart in FIG. 1(b) and are outlined further below. Reference to “AGAT LAB” refers to testing performed by an independent laboratory (AGAT Laboratories). Sweet gas (shown as “fuel gas” in FIGS. 1(a) and 1(b)) flowrate was measured in thousands of cubic feet per day (e3m3/d).

Day 1 Test 1 (packing in) in FIG. 1(b) illustrates the initial testing performed to determine the effect of the improvised static mixer having the stainless steel wingnut packing material installed therein (as shown in FIG. 1(a)) on H₂S removal from the sour water.

Day 1 Test 2 (packing out) in FIG. 1(b) illustrates the initial testing performed to determine the effect of the same pipe having the wingnuts removed on H₂S removal from the sour water. The results with the wingnuts removed illustrated far less encouraging results and illustrated that the wingnuts definitely made a difference in removing the H₂S from the produced water.

Day 2 Test 1 (packing in) in FIG. 1(b) illustrates a repeat of the testing performed to determine the effect of the improvised static mixer having the stainless steel wingnut packing material installed therein (as shown in FIG. 1(a)) on H₂S removal from the sour water. These results confirmed the results from Day 1 Test 1.

The test as outlined above and in FIGS. 1(a) and 1(b) was only partially successful in that H₂S was not able to be removed in an efficient fashion at lower concentrations of H₂S in the produced water, even after several stages of treatment.

A basic static mixing test similar to that outlined in FIG. 1(a) was performed on a larger scale using a 1000 bbl production tank located at the Todd Energy central facility. The system, process conditions and results are outlined in FIGS. 2(a) and 2(b).

The system includes a 1000 barrel (bbl) water tank for housing sour water obtained from a sour production water tank from a plant site located at a-44-I/94-A-13 (Todd Energy Canada). The water tank (vessel) was fluidly connected to a progressive cavity water pump for circulating water from the water tank through a 2 inch improvised static mixer (as described above in Materials and Methods) external to the water tank and back into the water tank through a water line.

As shown in FIG. 2(a), water was pumped out of the water tank via an outlet disposed at the base of the water tank (through a 3″ connection in the tank available for tie-in purposes) and directed through the static mixer together with the sweet gas (shown as “fuel gas” in the figure) and the mixture of water with sweet gas was then returned to the water tank from the water line via an inlet disposed at an end of the water tank opposite from the base of the water tank (through a 3″ connection located in the tank for high-level shut down purposes), which created a flow profile of the tank from top to bottom.

The volume of the tank was approximately 40 m³ (i.e. the tank was about ⅓ full), The flowrate through the static mixer in the water line was about 6.5 m³/hour. The water tank was located outside, and the temperatures of about 30° C. as noted in FIG. 2(b) are reflective of ambient temperatures during the time the experiment was conducted. The produced sour gas was directed to a vapor recovery unit (VRU). Other experimental details are outlined in FIG. 2(b).

As can be seen from the data shown in FIG. 2(b), the above-described process was effective to cause a reduction in H₂S levels in the sour water down to about 70 ppm, according to the Hach test, over the course of 29 hours. However, further reductions in the amount of H₂S were desirable, preferably over shorter timeframes.

Thus, the pilot tests as set forth in FIGS. 1(a), 1(b), 2(a) and 2(b) had some success in reducing H₂S from the sour water but not in a time effective fashion once the concentration of H₂S was below approximately 400 ppm. In order for this process to become viable other technologies had to be considered and tested to be used either independently or in conjunction with the static mixing technology.

### Comparative Example 2

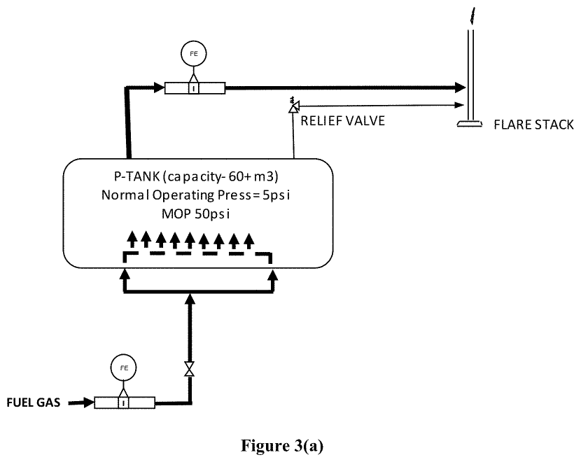

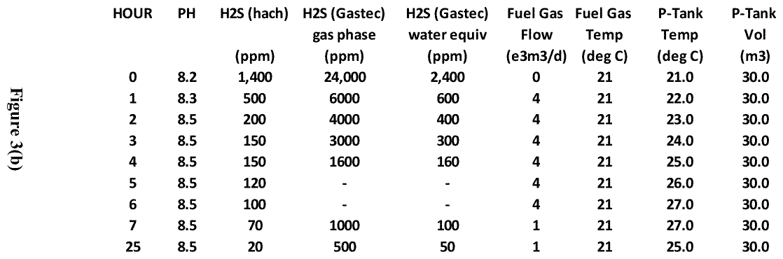

Further tests for sour water sweetening was carried out using a pressure tank (“P-Tank”), as shown in FIG. 3(a). The P-Tank was a production test vessel rented by Todd Energy from Colter as noted above in the Materials and Methods section; however, any appropriate P-Tank could be used. The P-tank had a capacity of 60 m³, a normal operating pressure of 5 psi, and a maximum operating pressure (MOP) of 50 psi. The rental P-Tank used in the present Example came equipped with a sparging device located at the base of the tank for the purpose of cleaning debris (e.g. sand from fracking) from the bottom of the P-tank by flushing water through the sparging device. The sparging device included two sets of sparging fingers in the form of perforated pipes oriented along the long axis of the tank and running in parallel to one another. Other companies offer P-tanks having similar water flushing setups that could also be implemented in the present process. The sour water used in the present Example was obtained from a sour production water tank from a plant site located at a-44-I/94-A-13 (Todd Energy Canada).

Note that reference to “FE” in FIG. 3(a) and in other Figures refers to gas meters through which fuel gas (a.k.a. sweet gas) and sour gas flow in the system. Rather than directing the produced sour gas to a VRU, the sour gas was directed to a flare stack as shown in FIG. 3(a).

FIGS. 3(a) and 3(b) illustrate the initial testing and results using the rental P-Tank. Experiments were conducted outdoors and thus the P-tank temperatures are reflective of ambient temperatures. While pH was monitored, no pH adjustments were made. Other test conditions and results are shown in FIG. 3(b). Although these tests yielded encouraging results, this technology by itself was not considered viable due to the duration of time required to sweeten water to an H₂S concentration of less than 20 ppm.

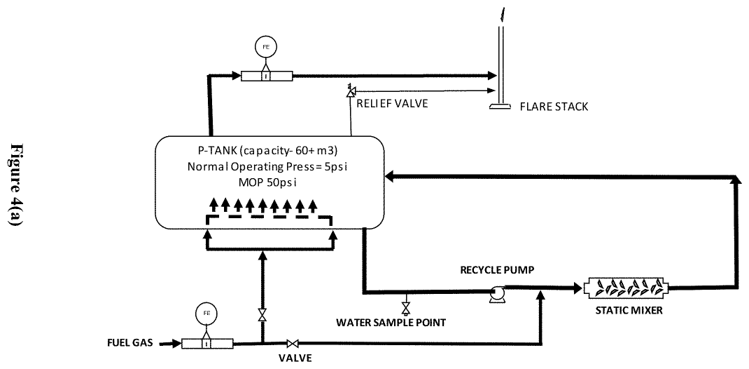

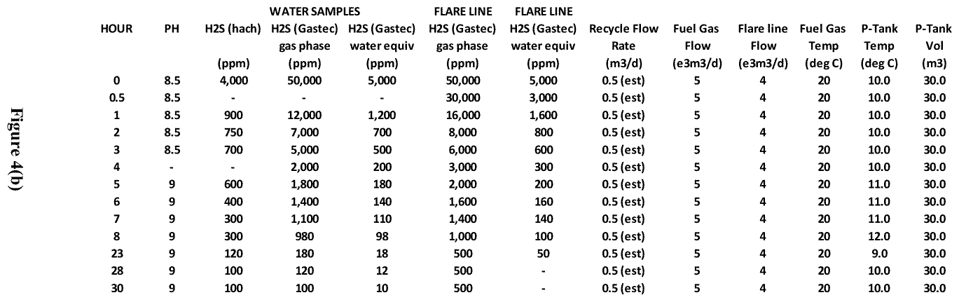

The features of a recycle loop and static mixer were then added to the system and process, as illustrated in FIG. 4(a). Similar to the setup shown in FIG. 2(a), the P-tank (vessel) was fluidly connected to a water pump for circulating water from the water tank through a 2-inch improvised static mixer (as described above in Materials and Methods) external to the water tank and back into the water tank through a water line. Also similar to the system shown in FIG. 2(a), water was pumped out of the water tank via an outlet disposed at the base of the water tank and directed through the static mixer together with the sweet gas (shown as “fuel gas” in the figure) and the mixture of water with sweet gas was then returned to the water tank from the water line via an inlet disposed at an end of the water tank opposite from the base of the water tank, which created a flow profile of the tank from top to bottom. The sweet gas was also used to sparge the water in the P-tank vessel. As in FIG. 3(a), the reference to “FE” in FIG. 4(a) refers to gas meters through which fuel gas (a.k.a. sweet gas) and sour gas flow in the system. Rather than directing the produced sour gas to a VRU, the sour gas was directed to a flare stack as shown in FIG. 4(a).

Again, experiments were conducted outdoors and thus the P-tank temperatures are reflective of ambient temperatures. While pH was monitored, no pH adjustments were made. Other test conditions and results are shown in FIG. 4(b).

Although these tests yielded encouraging results, this technology by itself was not considered viable due to the duration of time required to sweeten water to an H₂S concentration of less than 20 ppm.

### Example 3

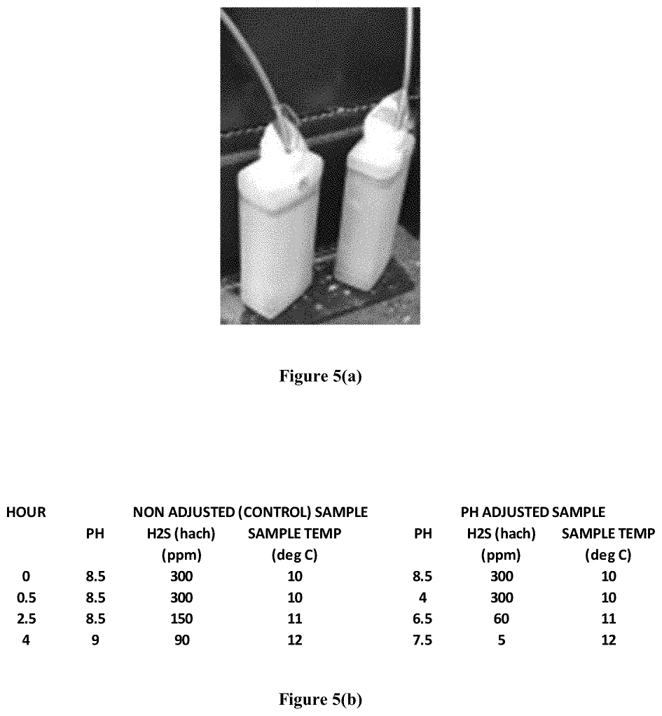

While performing the sparge testing as described above in Example 2, a ‘side test’ was performed, as shown in FIGS. 5(a) and 5(b). FIG. 5(a) illustrates a side-by-side 1 L bottle test that was conducted wherein approximately 950 mL of sour water in each bottle was sweetened. In one of the bottles, a one-time pH adjustment to pH 4 was made with dropwise addition of 37% hydrochloric acid (HCl). Each of the bottle tests involved sparging of the sour water with sweet gas wherein a simple plastic tube was used to bubble fuel gas in the water. The flowrate of the sweet gas was such that approximately 4 bubbles per second were observed. The sour water used in the present test and in other tests outlined in the present Example was obtained from a sour production water tank from a plant site located at a-44-I/94-A-13 (Todd Energy Canada).

FIG. 5(b) summarizes other experimental conditions as well as the results of this pilot test. This test showed promise of accelerating the removal of H₂S from the sour water, and a scale-up of these tests was conducted.

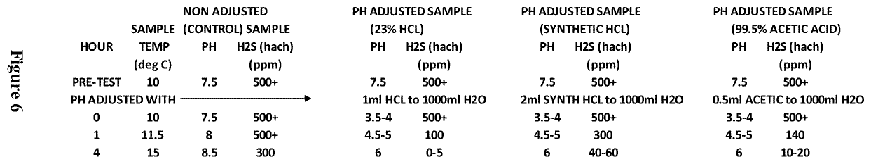

FIG. 6 illustrates experimental conditions and test results for four 10 L bottle tests that were conducted wherein approximately 9.5 L of sour water in each bottle was sweetened. In each of three of the bottles, a one-time pH adjustment to pH 4 was made with dropwise addition of HCl (23%), synthetic acid, and acetic acid (99.5% concentration). Each of the bottle tests involved sparging of the sour water with sweet gas wherein a simple plastic tube was used to bubble fuel gas in the water. The flowrate of the sweet gas was such that approximately 4 bubbles per second were observed. Again, these tests were very promising and accelerated the removal of H₂S from the sour water, with HCl giving the best results.

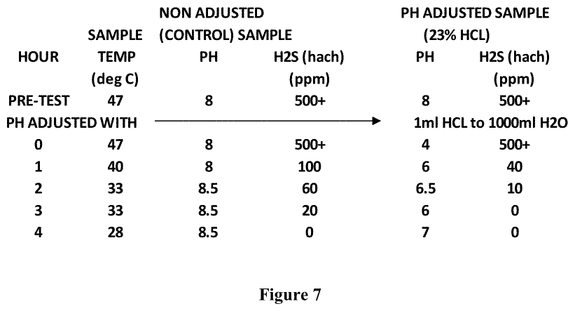

FIG. 7 illustrates experimental conditions and test results for two 1 L bottle tests carried out in a similar manner as the bottle tests described above, wherein approximately 950 mL of sour water in each bottle was sweetened. In one of the bottles, a one-time pH adjustment to pH 4 was made with dropwise addition of 23% hydrochloric acid (HCl). Each of the bottle tests involved sparging of the sour water with sweet gas wherein a simple plastic tube was used to bubble fuel gas in the water. The flowrate of the sweet gas was such that approximately 4 bubbles per second were observed. In addition, the bottle tests were performed in a heated bath, which provided the best results observed in the bottle testing experiments.

### Example 4

The next stage of testing centered on incorporating sparging technology in conjunction with pH adjustment using HCl performed in a tank of similar dimensions to that of a production tank but at one tenth of the scale. The intent of these tests was to further prove the effectiveness of these two technologies together but in an actual tank that would be reflective of a more realistic scenario/environment. The results from these tests were impressive and considered viable. The sour water used in all tests in the present Example was obtained from a sour production water tank from a plant site located at a-44-I/94-A-13 (Todd Energy Canada).

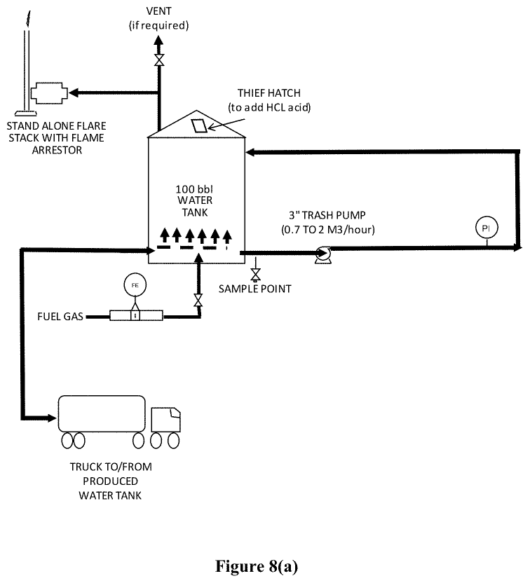

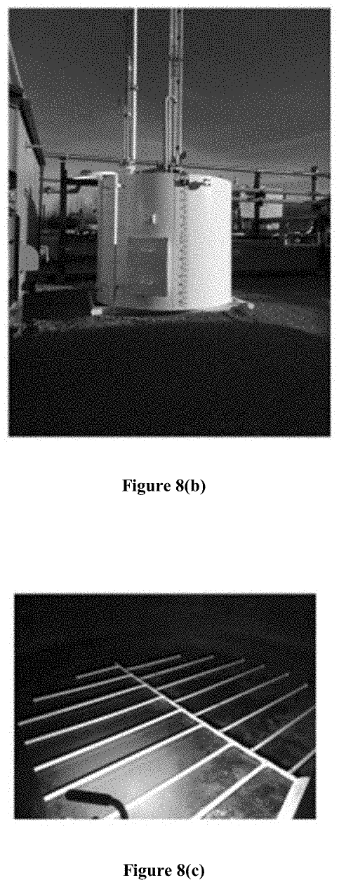

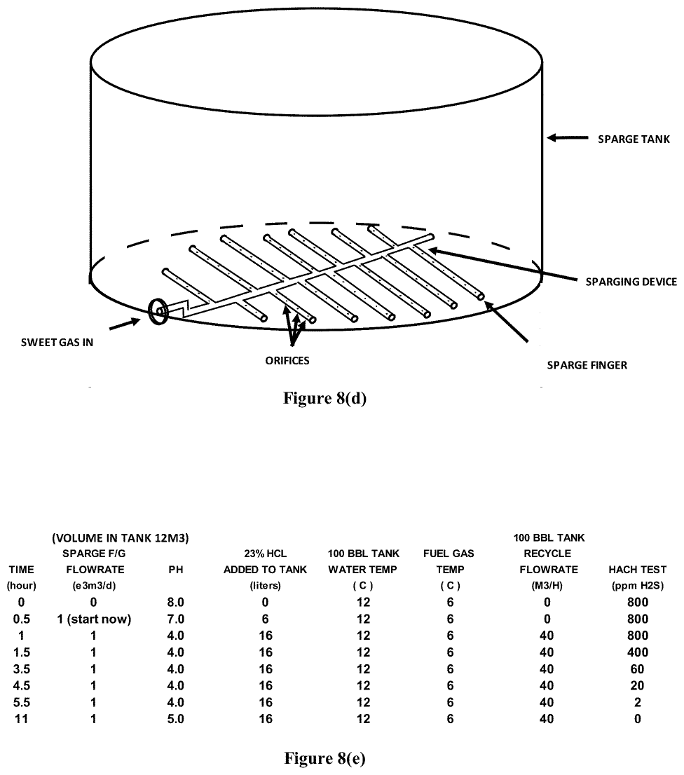

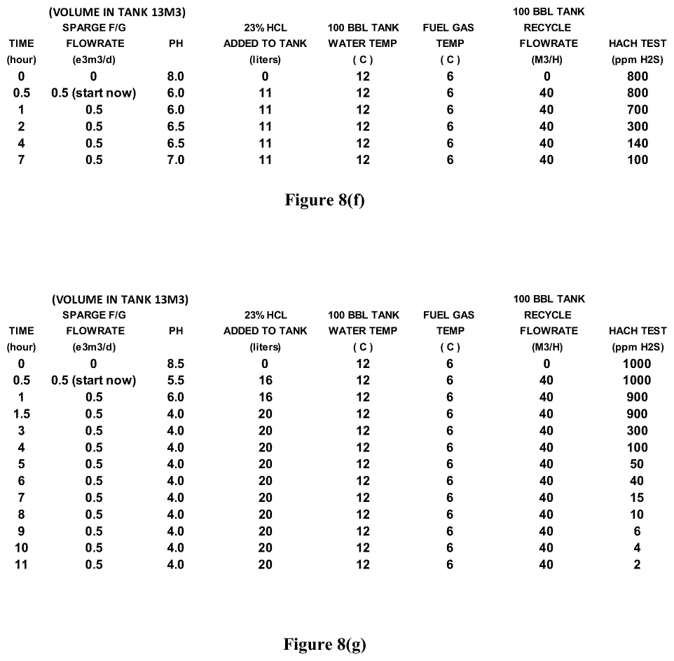

FIG. 8(a) illustrates a flow schematic for a 10:1 scale test with a 100 barrel (bbl) tank wherein sweet gas sparging technology was coupled with pH adjustment using HCl, together with a recycle loop, to sweeten sour water. As shown in FIG. 8(a), HCl was added to the tank at intervals via a thief hatch. The element “PI” is a pressure indicator/gauge, and “FE” is as noted above. FIGS. 8(b) and 8(c) are pictures of the 100 bbl tank used and sparging device comprising sparging fingers that was used for sparging the sour water housed in the tank with sweet gas. FIG. 8(d) is a simplified schematic of the sparging device installed in the tank.

For proof of concept, the sparging device as shown in FIG. 8(c) was constructed from polyvinylchloride (PVC) pipes; however, for permanent installation, the sparging device would be constructed from stainless steel, carbon steel, or alloy. The sparging fingers consisted of a design of 1 inch PVC pipe that was spaced out by utilizing 1 inch tee′d connections. The PVC connections and pipe were joined together using a compound cement/glue. The central pipe was about 8 feet in length constructed of 0.5-foot lengths of pipe connected using the tee connections described above. The sparging fingers varied in length according to the diameter of the tank as seen in FIG. 8(c). The ends of the sparging fingers comprised caps held on with a compound cement/glue. Orifices were drilled into the sparging fingers using a 5/64th inch drill bit (resulting in approximately 2 mm diameter holes), and the orifices were evenly spaced about 6 inches apart. The sparging fingers were spaced approximately 1 foot apart in the present example. It is noted that on scale-up to 1000 barrel tank, the fingers could be spaced further apart (e.g. 3 feet). In addition, in a permanent installation, pipe connections would use threaded/screwed connections for simplicity.

The piping for the recycle loop shown in FIG. 8(a) was a combination of 1 inch and 2 inch steel piping and connections. Sweet gas was supplied to the sparging device using a 1 inch flexible hose.

FIGS. 8(e), 8(f), and 8(g) show the experimental conditions and results of three separate experiments using this system and process. As noted above, the results from these tests were impressive and considered viable. It was found that maintaining the pH at levels less than about 6, and preferably from about 4 to about 5, gave superior results.

It is note that heating of the water, and static mixing within the recycle loop was not part of this test process, but could be incorporated therein as it would be expected to assist in a further reduction of time to meet the sweetened water specification.

### Prophetic Example 5

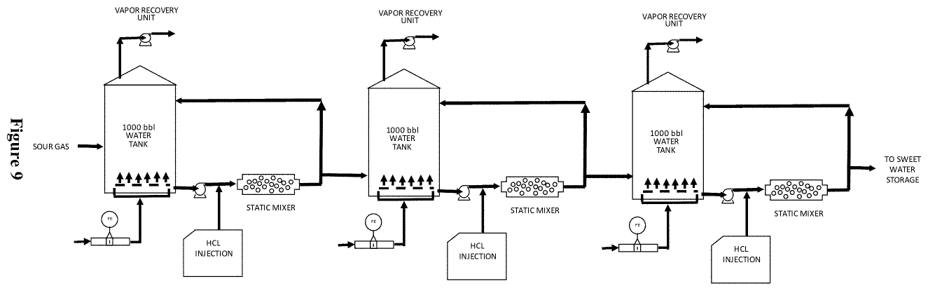

It is expected that the systems and methods as described above could be implemented in a continuous water sweetening process. FIG. 9 illustrates water sweetening via multi-stage treatment in series. As can be seen in FIG. 9, the treatment method includes the use of a series of systems similar to those described above and including sparging technology, pH adjustment, a static mixer, and a recycling loop, connected in series. In FIG. 9, the systems are connected via connections between the recycle loop of one system with a vessel (water tank) of a separate system; however, alternate connections could be provided.

The method of use of the multi-stage treatment in series broadly involves providing the sweetened water formed in a first vessel (water tank) to a second vessel (water tank) within a second system. The multi-stage treatment method further involves adjusting the pH of the sweetened water to, or maintaining the pH of the sweetened water at, a pH of less than about 6 by addition of acid to the sweetened water housed in the second vessel, as needed, to form or maintain acidified sweetened water, and then sparging the acidified sweetened water in the second vessel with sweet gas to produce a second batch of sour gas and a further sweetened water, and separating the sour gas from the further sweetened water. The further sweetened water can then be directed to a third vessel (water tank) within a third system and so forth. The number of stages required in the treatment will vary depending on the initial H₂S content of the sour water that is being subjected to the multi-stage treatment.

All publications, patents and patent applications mentioned in this Specification are indicative of the level of skill of those skilled in the art to which this invention pertains and are herein incorporated by reference to the same extent as if each individual publication, patent, or patent application was specifically and individually indicated to be incorporated by reference.

Although the present invention has been described with reference to the preferred embodiments, it is to be understood that modifications and variations may be resorted to without departing from the spirit and scope of the invention, as those skilled in the art readily understand. Such modifications and variations are considered to be within the purview and scope of the invention and the appended claims.

1. A process for removing hydrogen sulfide from sour water, comprising:
obtaining sour water;
adjusting the pH of the sour water to a pH of less than about 6 by addition of a first acid to form acidified sour water;
sparging the acidified sour water with a first hydrocarbon gas in a first vessel to produce a first sour gas and a sweetened water; and
separating the first sour gas from the sweetened water.

2. The process of claim 1, wherein the first acid comprises hydrochloric acid, acetic acid, or a combination thereof.

3. The process of claim 2, wherein the first acid is hydrochloric acid.

4. The process of any one of claims 1-3, wherein the first hydrocarbon gas is sweet gas.

5. The process of any one of claims 1-4, wherein the pH of the acidified sour water is from about 3.5 to about 5.5.

6. The process of any one of claims 1-5, wherein the pH of the acidified sour water is from about 4 to about 5.

7. The process of any one of claims 1-6, wherein the pH is maintained substantially constant during the process.

8. The process of any one of claims 1-7, wherein the first vessel comprises a first sparging device for sparging the acidified sour water with the first hydrocarbon gas, the first sparging device being located at a base of the first vessel.

9. The process of any one of claims 1-8, wherein the first sparging device comprises at least one sparging finger fluidly connected to a source of the first hydrocarbon gas and disposed horizontally within the first vessel, wherein the sparging finger comprises a pipe with a plurality of orifices for releasing the first hydrocarbon gas into the first vessel.

10. The process of claim 9, wherein the plurality of orifices are evenly spaced apart from one another.

11. The process of claim 9 or 10, wherein the first sparging device comprises a plurality of sparging fingers.

12. The process of any one of claims 1-11, further comprising:
removing a portion of the sour water from the first vessel, optionally via an outlet disposed at the base of the first vessel;
mixing, externally to the first vessel, the portion of the sour water from the first vessel together with a portion of the first hydrocarbon gas, and optionally a portion of the first acid, to form a first mixture; and
providing the first mixture to the first vessel;
optionally, wherein the first mixture is provided to the first vessel via an inlet disposed at an end of the first vessel opposite from the base of the first vessel.

13. The process of claim 12, wherein said mixing is carried out using a first static mixer.

14. The process of claim 12 or 13, wherein said steps of removing the portion of the sour water from the first vessel; mixing, externally to the first vessel, the portion of the sour water from the first vessel together with the portion of the first hydrocarbon gas, and optionally the portion of the first acid, to form the first mixture; and providing the first mixture to the first vessel are performed periodically during the process for removing hydrogen sulfide from the sour water.

15. The process of claim 12 or 13, wherein said steps of removing the portion of the sour water from the first vessel; mixing, externally to the first vessel, the portion of the sour water from the first vessel together with the portion of the first hydrocarbon gas, and optionally the portion of the first acid, to form the first mixture; and providing the first mixture to the first vessel are performed continuously during the process for removing hydrogen sulfide from the sour water.

16. The process of any one of claims 1-15, further comprising incinerating the first sour gas following the step of separating the first sour gas from the sweetened water.

17. The process of any one of claims 1-15, further comprising sending the first sour gas to a vapour recovery unit to be sweetened and recycled to the process following the step of separating the first sour gas from the sweetened water.

18. The process of any one of claims 1-17, further comprising:
providing the sweetened water formed in the first vessel to a second vessel;
adjusting the pH of the sweetened water to or maintaining the pH of the sweetened water at a pH of less than about 6 by addition of a second acid to the sweetened water, as needed, to form or maintain acidified sweetened water;
sparging the acidified sweetened water in the second vessel with a second hydrocarbon gas to produce a second sour gas and a further sweetened water; and
separating the second sour gas from the further sweetened water.

19. The process of claim 18, wherein the second acid comprises hydrochloric acid, acetic acid, or a combination thereof.

20. The process of claim 19, wherein the second acid is hydrochloric acid.

21. The process of any one of claims 18-20, wherein the second hydrocarbon gas is sweet gas.

22. The process of any one of claims 18-21, wherein the pH of the acidified sweetened water is from about 3.5 to about 5.5.

23. The process of any one of claims 18-22, wherein the pH of the acidified sweetened water is from about 4 to about 5.

24. The process of any one of claims 18-23, wherein the pH is maintained substantially constant during the process.

25. The process of any one of claims 18-24, wherein the second vessel comprises a second sparging device for sparging the acidified sweetened water with the second hydrocarbon gas, the second sparging device being located at a base of the second vessel.

26. The process of any one of claims 18-25, wherein the second sparging device comprises at least one sparging finger fluidly connected to a source of the second hydrocarbon gas and disposed horizontally within the second vessel, wherein the sparging finger comprises a pipe with a plurality of orifices for releasing the second hydrocarbon gas into the second vessel.

27. The process of claim 26, wherein the plurality of orifices are evenly spaced apart from one another.

28. The process of claim 26 or 27, wherein the second sparging device comprises a plurality of sparging fingers.

29. The process of any one of claims 18-28, further comprising:
removing a portion of the sweetened water from the second vessel optionally via an outlet disposed at the base of the second vessel;
mixing, externally to the second vessel, the portion of the sweetened water from the second vessel together with a portion of the second hydrocarbon gas, and optionally a portion of the second acid, to form a second mixture; and
providing the second mixture to the second vessel;
optionally, wherein the second mixture is provided to the second vessel via an inlet disposed at an end of the second vessel opposite from the base of the second vessel.

30. The process of claim 29, wherein said mixing is carried out using a second static mixer.

31. The process of claim 29 or 30, wherein said steps of removing the portion of the sweetened water from the second vessel; mixing, externally to the second vessel, the portion of the sweetened water from the second vessel together with the portion of the second hydrocarbon gas, and optionally the portion of the second acid, to form the second mixture; and providing the second mixture to the second vessel are performed periodically during the process for removing hydrogen sulfide from the sour water.

32. The process of claim 29 or 30, wherein said steps of removing the portion of the sweetened water from the second vessel; mixing, externally to the second vessel, the portion of the sweetened water from the second vessel together with the portion of the second hydrocarbon gas, and optionally the portion of the second acid, to form the second mixture; and providing the second mixture to the second vessel are performed continuously during the process for removing hydrogen sulfide from the sour water.

33. The process of any one of claims 18-32, further comprising incinerating the second sour gas following the step of separating the second sour gas from the further sweetened water.

34. The process of any one of claims 18-32, further comprising sending the second sour gas to the vapour recovery unit to be sweetened and recycled to the process following the step of separating the second sour gas from the further sweetened water.

35. The process of any one of claims 1-17, wherein the sweetened water is sent to a storage tank following the step of separating the first sour gas from the sweetened water.

36. The process of any one of claims 18-34, wherein the further sweetened water is sent to a storage tank following the step of separating the second sour gas from the further sweetened water.

37. The process of any one of claims 18-34, further comprising:
providing the further sweetened water formed in the second vessel to a third vessel for further sweetening of the water.

38. The process of any one of claims 18-37, wherein the first acid and the second acid are the same acid.

39. The process of claim 38, wherein the first acid and the second acid are hydrochloric acid.

40. The process of any one of claims 18-39, wherein the first hydrocarbon gas and the second hydrocarbon gas are the same gas.

41. The process of claim 40, wherein the first hydrocarbon gas and the second hydrocarbon gas are sweet gas.

42. The process of any one of claims 1-41, wherein the process is conducted in an oxygen-free environment.

43. The process of any one of claims 1-17, further comprising heating the first vessel during the process.

44. The process of any one of claims 18-42, further comprising heating the first vessel and/or heating the second vessel during the process.
